(19) United States
(12) Patent Application Publication
(10) Pub. No.: US 2002/0095831 A1
(43) Pub. Date: Jul. 25, 2002

(54) Soft-shelled ornament filled with fluid

(76) Inventor: Jui-An Tsai, Tao Yuan Hsien (TW)

Correspondence Address: DOUGHERTY & TROXELL, SUITE 1404, 5205 LEESBURG PIKE, SUITE 1404, FALLS CHURCH, VA, 22401-3401, US

(21) Appl. No.: 09/767,874

(22) Filed: Jan. 24, 2001

(51) Int. Cl. G09F 19/00

(52) U.S. Cl. 40/410; 40/406

(57) ABSTRACT

A soft-shelled ornament filled with fluid is provided. The soft shell of the ornament has a lower opening around which a radially inward extended flange is provided. The soft shell is connected to a base by positioning the flange between a top of the base and a retaining member that is seated on the base, and tightening a screw nut onto a lower stem of the retaining member to pull the latter toward the base and thereby pinch the flange of the soft shell between the base and the retaining member. A plunger is extended through a central hole of the retaining member with an expanded head normally pulled downward by a compression spring around the plunger to seal the central hole. When the plunger is upward pushed at a bottom thereof, fluid may be supplied from the plunger into the soft shell via a port provided on the plunger. And, when the soft shell has been fully filled with the fluid and the plunger is released, the compression spring automatically pulls the plunger downward to seal the central hole of the retaining member.

### FIELD OF THE INVENTION

The present invention relates to a soft-shelled ornament filled with fluid, and more particularly to a soft-shelled ornament that could be easily filled with a fluid and is well leakproof. The ornament includes an injection-molded soft shell, a lower flange of which is pinched between a base and a retaining member of the ornament, and a plunger extended through a central hole of the retaining member to be either pulled downward by a compression spring to seal the central hole or pushed upward by an external force to project into the soft shell and allow supplying of a fluid into the soft shell.

### BACKGROUND OF THE INVENTION

The soft-shelled ornament is also referred to as a soft water ball ornament. Thermoplastic plastics or other similar materials are used to form a soft shell into which a fluid is filled to replace the conventional fragile glass-made crystal balls. The manner of filling the soft shell with a fluid and preventing the fluid-filled soft shell from leaking, as well as the manner of connecting the soft shell to a base of the ornament, form a very important part of such soft-shelled ornament. There are many soft-shelled ornaments developed and available in the markets.

However, to ensure leakproof products, these conventional soft-shelled ornaments usually involve complicated structure that adversely affects manufacture and cost thereof.

### SUMMARY OF THE INVENTION

It is a primary object of the present invention to provide a soft-shelled ornament filled with fluid, in which the soft shell is made of thermoplastic plastics or other similar materials through high-pressure injection molding and is therefore more rigid and changeful than the conventional soft shells.

Another object of the present invention is to provide a soft-shelled ornament filled with fluid, in which the soft shell has a lower opening around which a flange is provided, such that the soft shell can be easily connected to a base of the ornament simply by pinching the flange of the soft shell between the base and a retaining member that is firmly pulled downward to the base by a screw nut screwed onto a lower stem of the retaining member.

A further object of the present invention is to provide a soft-shelled ornament filled with fluid, in which the soft shell can be easily filled with the fluid through operation of a plunger.

To achieve the above and other objects, the soft shell of the ornament according to the present invention has a lower opening around which a radially inward extended flange is provided. The soft shell is connected to a base by positioning the flange between a top of the base and a retaining member that is seated on the base, and tightening a screw nut onto a lower stem of the retaining member to pull the latter downward to the base and thereby pinch the flange of the soft shell between the base and the retaining member. A plunger is extended through a central hole of the retaining member with an expanded head normally pulled downward by a compression spring around the plunger to seal the central hole. When the plunger is upward pushed at a bottom thereof, a desired type of fluid may be supplied into the soft shell from an inner space of the plunger via a port provided on the plunger to communicate the plunger with the soft shell. And, when the soft shell has been fully filled with the fluid and the plunger is released, the compression spring automatically pulls the plunger downward to seal the central hole of the retaining member.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective of a soft-shelled ornament filled with fluid according to an embodiment of the present invention;

FIG. 2 is an exploded perspective of the soft-shelled ornament according to the present invention before being filled with fluid;

FIG. 3 is a fragmentary sectional view of the soft-shelled ornament of the present invention, showing the manner of filling the soft shell of the ornament with fluid;

FIG. 4 is another fragmentary sectional view of the soft-shelled ornament of the present invention, showing a lower opening of the soft shell of the ornament is closed after the soft shell has been filled with fluid; and

FIG. 5 is a perspective of a soft-shelled ornament filled with fluid according to another embodiment of the present invention.

### DETAILED DESCRIPTION OF THE PREFERRED EMBODIMENTS

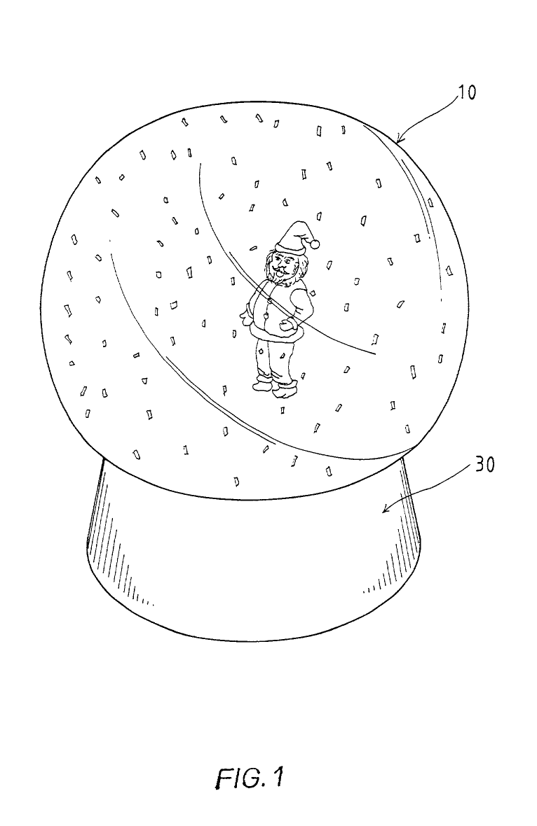

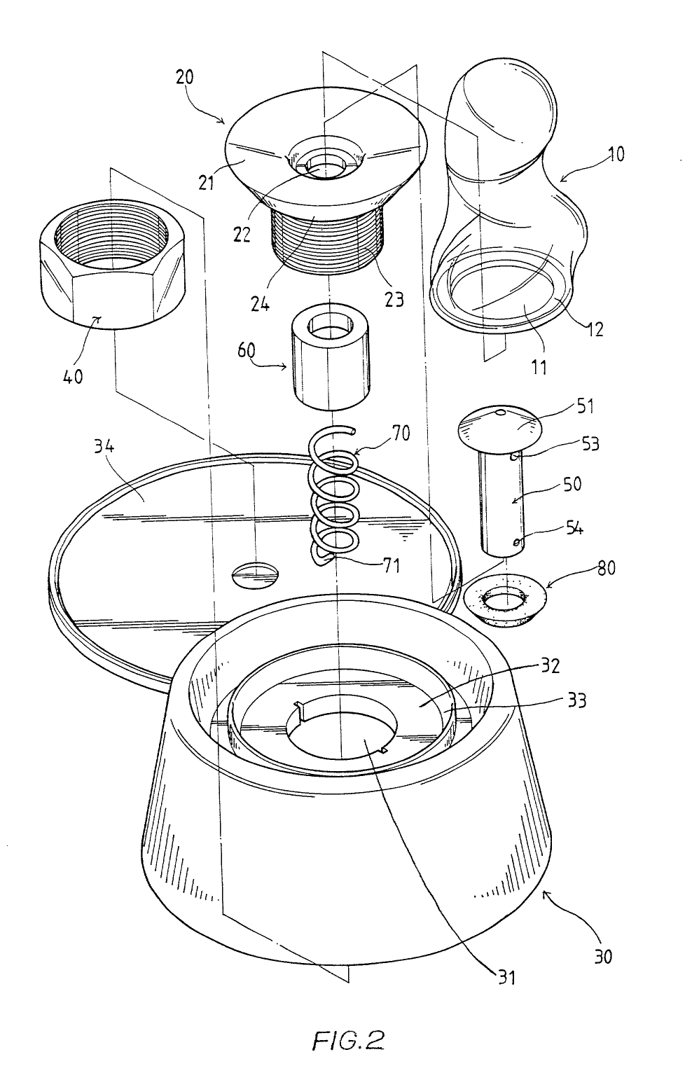

Please refer to FIGS. 1, 2, 3 and 4 in which a soft-shelled ornament filled with fluid according to an embodiment of the present invention is shown. The ornament mainly includes a soft shell 10, a retaining member 20, a base 30, a nut 40, and a plunger 50.

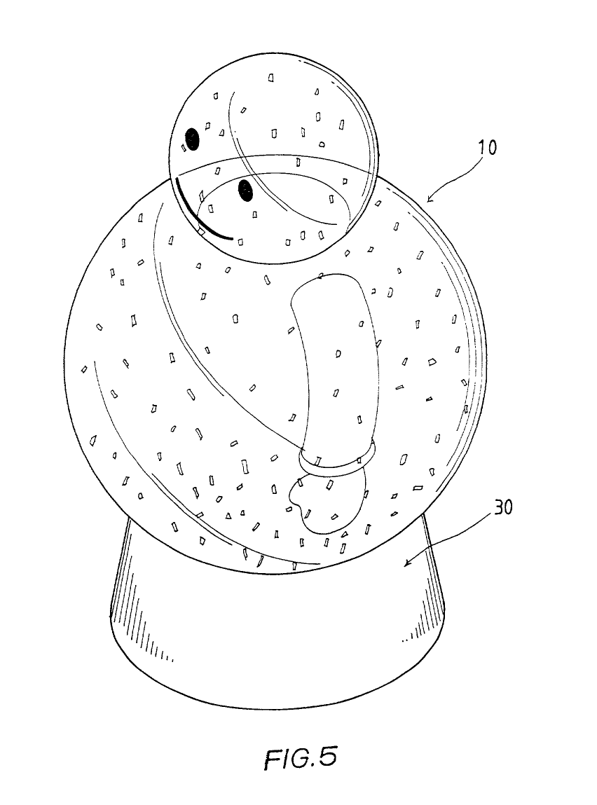

The soft shell 10 is a soft clear bag made of thermoplastic plastics or other similar materials through high-pressure injection molding, and is therefore more changeful in shape and more durable for use than other soft shells that are not formed through injection molding. FIG. 5 shows another embodiment of the present invention that has an appearance different from that of the embodiment shown in FIG. 1. The soft shell 10 has a lower opening 11. A radially inward extended flange portion 12 having a predetermined width is provided along the lower opening 11.

The retaining member 20 is in a shape similar to a screw bolt and has a diameter-expanded head portion 21, an externally threaded stem portion 23, a central stepped hole 22 vertically extended through the head portion 21 and the stem portion 23, and at least one circle of downward pointed wall 24 extended along a lower outer edge of the expanded head portion 21.

The base 30 may be of any shape but shall always have a top round opening 31 corresponding to the stem portion 23 of the retaining member 20 for the stem portion 23 to extend therethrough, a top annular surface 32 around the top round opening 31, and a circle of upward pointed wall 33 on the top annular surface 32. The upward pointed wall 33 defines a diameter larger than that defined by the downward pointed wall 24. To connect the soft shell 10 to the base 30, first extend the stem portion 23 of the retaining member 20 down through the top round opening 31 of the base 30, so that the expanded head portion 21 of the retaining member 20 is seated in the top annular surface 32 of the base 30 with the flange portion 12 of the soft shell 10 located between the top annular surface 32 and the expanded head portion 21. Then, fasten the screw nut 40 onto the externally threaded stem portion 23, that is now located below the top annular surface 32, so that the entire retaining member 20 is brought downward to tightly press against the base 30. At this point, a radially inner portion of the flange portion 12 of the soft shell 12 is bent by and pinched between the downward pointed wall 24 and the top round surface 32, and a radially outer portion of the flange portion 12 is bent by and pinched between the upward pointed wall 33 and an outer periphery of the expanded head portion 21, making the entire soft shell 10 firmly connect to a top of the base 30.

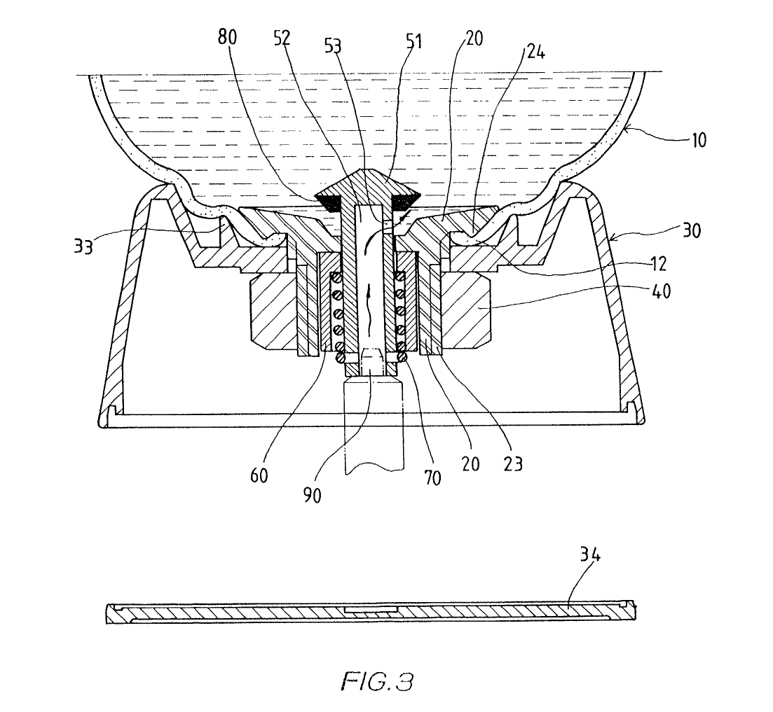

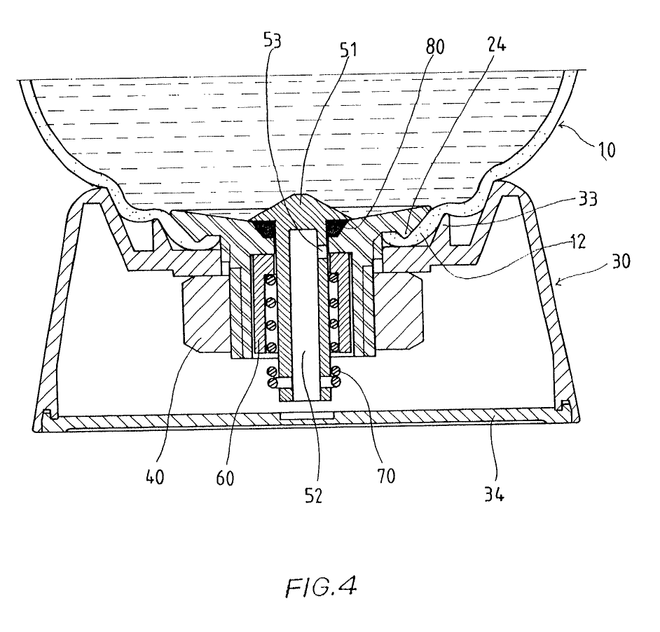

The plunger 50 has an expanded head portion 51 and defines an inner space 52. The plunger 50 is downward extended into the retaining member 20 via the central stepped hole 22, so that the expanded head portion 51 is vertically movably seated in a top of the central stepped hole 22. A bushing 60 is fitly disposed in the central stepped hole 22 corresponding to the stem portion to receive the plunger 50 therein. A compression spring 70 is put around the plunger 50 and housed by the bushing 60. A leakproof seal ring 80 is put around the plunger 50 immediately below the expanded head portion 51. As can be seen from FIGS. 3 and 4, it is possible to apply an upward force at a lower end of the plunger 50 to shift the same upward in the bushing 60 with the compression spring 70 being compressed. At this point, the expanded head portion 51 and the seal ring 80 project from the central stepped hole 22 into the soft shell 10. And, when the upward force is removed, a restoring force of the compression spring 70 pulls the plunger 50 downward, so that the expanded head portion 51 and the leakproof seal ring 80 move downward to seal the central stepped hole 22 again.

A radial port 53 is provided on the plunger 50 to communicate with the inner space 52. The port 53 is so located that it communicates the inner space 52 with an inner space of the soft shell 10 when the plunger 50 is shifted upward with the expanded head portion 51 and the leakproof seal ring 80 moved into the soft shell 10. With this structure, a desired type of fluid could be easily supplied into the soft shell 10 simply by aligning, for example, a head 90 of a syringe or other filling means with a bottom end of the inner space 52 of the plunger 50 and pushing the latter upward until the port 53 is located in the soft shell 10, as shown in FIG. 3. At this point, the fluid flows into the soft shell 10 in a direction indicated by the arrows in FIG. 3. After the soft shell 10 is fully filled with the fluid, simply remove the syringe head 90 from the bottom of the plunger 50 and the restoring force of the compression spring 70 automatically and quickly pulls back the plunger 50 to seal the central stepped hole 22, and the port 53 no longer communicates the inner space 52 with the inner space of the soft shell 10. After the soft shell 10 has been filled with fluid, a bottom of the base 30 is closed with a bottom cover 34.

The compression spring 70 may be easily located in the bushing 60 around the plunger 50 by hooking a locating 71 of the spring 70 to a locating hole 54 provided on the plunger 50 at a predetermined position. For the plunger 50 to always shift upward by a predetermined distance under an upward force in order to allow the port 53 to communicate the inner space 52 with the inner space of the soft shell 10, a stopper (not shown) may be provided on the plunger 50 above the locating hole 54 to, on the one hand, hold the compression spring 70 in place, and on the other hand, to press against a bottom of the bushing 60 and serve as an end of an upward travel of the plunger 50 in the bushing 60. It is understood more than one port 53 can be provided on the plunger 50, though only one port 53 is shown in the drawings.

The soft-shelled ornament of the present invention could be easily filled with desired type of fluid to facilitate the manufacture thereof. The ornament of the present invention also has novel structure that provides good leakproof effect and is therefore practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A soft-shelled ornament filled with fluid, comprising a soft shell, a retaining member, a base, a screw nut, and a plunger;
said soft shell being a soft clear bag made of thermoplastic plastics or other similar materials through high-pressure injection molding, and having a lower opening, around which a radially inward extended flange portion having a predetermined width is formed;
said retaining member including a diameter-expanded head portion, an externally threaded stem portion, and a central stepped hole extended through said head portion and said stem portion, said expanded head portion being provided along a lower outer periphery with at least one circle of downward pointed wall, and a bushing being fitted in a lower portion of said central stepped hole corresponding to said stem portion;
said base including a top round opening via which said stem portion of said retaining member is downward extended to locate below said base, a top annular surface extended around said top round opening, and a circle of upward pointed wall provided on said top annular surface at a predetermined position; and said upward pointed wall defining a diameter larger than that defined by said at least one circle of downward pointed wall of said retaining member; and
said plunger being adapted to downward extend through said central stepped hole of said retaining member into said bushing, such that an expanded head portion of said plunger is seated at a top of said central stepped hole, a leakproof seal ring being located immediately below said expanded head portion, said plunger defining an inner space and having a radial fluid port provided below said expanded head portion by a predetermined distance to communicate with said inner space, and a compression spring being put around said plunger and housed by said bushing to normally pull said plunger downward to seal said central stepped hole of said retaining member; and
said soft shell being connected to said base by locating said flange portion between said expanded head portion of said retaining member and said top annular surface of said base, and tightening said screw nut around said externally threaded stem portion of said retaining member to bring the latter to tightly press against said base and thereby pinch said flange portion between said expanded head portion of said retaining member and said top annular surface of said base while bend said flange portion at said at least one circle of downward pointed wall and said one circle of upward pointed wall, so that a watertight connection between said soft shell and said base is provided; and
said compression spring being compressed and said plunger being upward moved when an upward force is applied at a bottom of said plunger, allowing a desired type of fluid to be supplied from said inner space of said plunger into said soft shell via said radial fluid port that communicates said inner space of said plunger with an inner space of said soft shell; and a restoring force of said compression spring being able to pull said plunger downward to seal said central stepped hole of said retaining member when said upward force is removed from the bottom of said plunger, and bringing said radial fluid port to a position no longer communicating said inner space of said plunger with said inner space of said soft shell.
